(19) United States
(12) Patent Application Publication
(10) Pub. No.: US 2014/0092246 A1
(43) Pub. Date: Apr. 3, 2014

(54) GATEWAY APPARATUS FOR MONITORING ELECTRONIC DEVICES AND CONTROL METHOD THEREOF

(71) Applicant: Samsung Electronics Co. Ltd., Suwon-si (KR)

(72) Inventors: Bon-Hyun KOO, Suwon-si (KR); Je-Hyok RYU, Suwon-si (KR)

(73) Assignee: Samsung Electronics Co. Ltd., Suwon-si (KR)

(21) Appl. No.: 14/037,806

(22) Filed: Sep. 26, 2013

(30) Foreign Application Priority Data
Sep. 28, 2012 (KR) 10-2012-0109427

(51) Int. Cl. H04N 7/18

(52) U.S. Cl. CPC H04N 7/183
USPC 348/143

(57) ABSTRACT

A gateway apparatus for monitoring whether something is wrong with electronic devices and a control method thereof are provided. The gateway apparatus includes at least one communication section which communicates with a plurality of electronic devices, a camera for taking an image of the plurality of electronic devices, and a user terminal or a management server, and a controller configured to determine whether there is something wrong with at least one of the plurality of electronic devices based on energy information received from the plurality of electronic devices, to receive a taken image of the at least one electronic device with which something is wrong from the camera by transmitting position information of the at least one electronic device with which something is wrong to the camera, and to transmit a monitoring image based on the received taken image of the at least one electronic device with which something is wrong to the user terminal or to the management server.

### CROSS-REFERENCE TO RELATED APPLICATION(S)

This application claims the benefit under 35 U.S.C. §119(a) of a Korean patent application filed on Sep. 28, 2012 in the Korean Intellectual Property Office and assigned Serial No. 10-2012-0109427, the entire disclosure of which is hereby incorporated by reference.

### TECHNICAL FIELD

The present disclosure relates to a gateway apparatus for monitoring electronic devices and a control method thereof. More particularly, the present disclosure relates to a gateway apparatus for monitoring whether there is something wrong with electronic devices and a control method thereof.

### BACKGROUND

Electronic devices, which include a Television (TV), an air conditioner, a refrigerator, a computer, a printer, home appliances, industrial electronic equipment, office machines, or the like, may operate without a user. A user may remain informed about one of these electronic devices by monitoring its operations.

For such monitoring, a gateway apparatus based on network communication has been used. The gateway apparatus may obtain the operational status of the electronic device(s) through various methods in order to determine whether there is something wrong with the operations of the electronic device(s), and then may transmit a result of the determination to a user's terminal or to a management server.

However, a gateway apparatus of the related art has a problem in that information given to a user's terminal or to a management server is insufficient to be used by a user for determining whether there is something wrong with the electronic device(s).

Also, if there are several electronic devices, or if the electronic device(s) are in a position where monitoring is not easy, it is difficult to correctly monitor the electronic device(s) to determine if something is wrong.

Therefore, a need exists for a gateway apparatus and related control method for effectively monitoring the status of an electronic device in order to determine if something is wrong therewith.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a gateway apparatus capable of monitoring an electronic device having something wrong, while allowing a user to intuitively check whether there is something wrong with the electronic devices, and a control method thereof.

In accordance with an aspect of the present disclosure, a gateway apparatus for monitoring whether something is wrong with electronic devices is provided. The gateway apparatus includes at least one communication section which communicates with a plurality of electronic devices, a camera for taking an image of the plurality of electronic devices, and a user terminal or a management server, and a controller configured to determine whether there is something wrong with at least one of the electronic devices based on energy information received from the plurality of electronic devices, to receive a taken image of the at least one of the electronic devices with which something is wrong from the camera by transmitting position information of the at least one electronic device with which something is wrong to the camera, and to transmit a monitoring image based on the received taken image of the at least one electronic device with which something is wrong to the user terminal or to the management server.

The controller may determine whether there is something wrong with at least one of the plurality of electronic devices based on operation information received from the plurality of electronic devices.

The energy information may include information about periodic energy consumption of the electronic devices.

The controller may determine whether there is something wrong with at least one of the plurality of electronic devices using a probabilistic algorithm based on information about the periodic energy consumption of the plurality of electronic devices.

The controller may determine that something is wrong with at least one of the plurality of electronic devices when an occurrence probability of current energy consumption of the at least one of the plurality of electronic devices is lower, by a threshold value, than that of previous energy consumption of the electronic device.

The probabilistic algorithm may include a Bayesian estimation method.

The communication section may receive the energy information from the plurality of electronic devices through Zigbee communication.

The monitoring image may include information to distinguish the at least one electronic device with which something is wrong from among the plurality of electronic devices.

In accordance with another aspect of the present disclosure, a method of controlling a gateway apparatus for monitoring whether something is wrong with electronic devices is provided. The method includes receiving energy information from a plurality of electronic devices, determining whether there is something wrong with at least one of the electronic devices based on energy information received from the plurality of electronic devices, when there is something wrong with at least one of the plurality of electronic devices, transmitting position information of the at least one electronic device with which something is wrong to a camera for taking images of the plurality of electronic devices, receiving the taken image of the at least one electronic device with which something is wrong from the camera, and transmitting a monitoring image based on the taken image of the at least one electronic device with which something is wrong to the user terminal or management server.

The determining of whether there is something wrong may include determining whether something is wrong with at least one of the plurality of electronic devices, based on operation information received from the plurality of electronic devices.

The energy information may include information about periodic energy consumption of the electronic devices.

The determining of whether there is something wrong may include determining whether there is something wrong with at least one of the plurality of electronic devices through a probabilistic algorithm based on information about the periodic energy consumption of the plurality of electronic devices.

The determining of whether there is something wrong may include determining that something is wrong with at least one of the plurality of electronic devices when an occurrence probability of current energy consumption of at least one of the plurality of electronic devices with which something is wrong is lower, by a threshold value, than that of previous energy consumption of the electronic device.

The probabilistic algorithm may include a Bayesian estimation method.

The method may further include receiving the energy information from the plurality of electronic devices through Zigbee communication.

The monitoring image may include information to distinguish the at least one electronic device with which something is wrong from among the plurality of electronic devices.

In accordance with another aspect of the present disclosure, a gateway apparatus for monitoring whether something is wrong with electronic devices is provided. The gateway apparatus includes at least one communication section which communicates with a plurality of electronic devices, a camera for taking an image of the plurality of electronic devices, and a user terminal or a management server, and a controller configured to receive operation information from the plurality of electronic devices, to determine whether there is something wrong with at least one of the electronic devices by comparing the received operation information with operation conditions, to receive an image of the at least one of the electronic devices with which something is wrong from the camera by transmitting position information of the at least one electronic device with which something is wrong to the camera, and to transmit the received image of the at least one electronic device with which something is wrong to the user terminal or to the management server.

In accordance with another aspect of the present disclosure, a method of controlling a gateway apparatus for monitoring whether something is wrong with electronic devices is provided. The method includes receiving operation information from a plurality of electronic devices, determining whether there is something wrong with at least one of the plurality of electronic devices by comparing the received operation information with operation conditions, transmitting position information of the at least one of the electronic devices with which something is wrong to a camera for taking images of the plurality of electronic devices if something is wrong, receiving the image of the at least one electronic device with which something is wrong from the camera, and transmitting a monitoring image based on the taken image of the at least one electronic device with which something is wrong to a user terminal or to a management server.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a gateway apparatus and various electronic devices according to an embodiment of the present disclosure;

FIG. 2 shows an example of operations of a gateway apparatus according to an embodiment of the present disclosure;

FIG. 3 shows another example of operations of a gateway apparatus according to an embodiment of the present disclosure;

FIG. 4 is a block diagram showing a configuration of a gateway apparatus according to an embodiment of the present disclosure;

FIG. 5 is a block diagram showing a configuration of a camera according to an embodiment of the present disclosure;

FIG. 6 is a flowchart showing operations of a gateway apparatus according to an embodiment of the present disclosure;

FIG. 7 illustrates an example of a smart energy profile stack according to an embodiment of the present disclosure;

FIG. 8 illustrates a frame structure of a profile containing energy information according to an embodiment of the present disclosure;

FIG. 9 illustrates a distribution of event occurrence of energy consumption according to an embodiment of the present disclosure;

FIG. 10 illustrates probability of each event obtained based on the distribution of an event according to an embodiment of the present disclosure;

FIGS. 11 and 12 show examples of monitoring images according to an embodiment of the present disclosure; and

FIG. 13 is a flowchart showing operations of the gateway apparatus according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Below, various embodiments will be described.

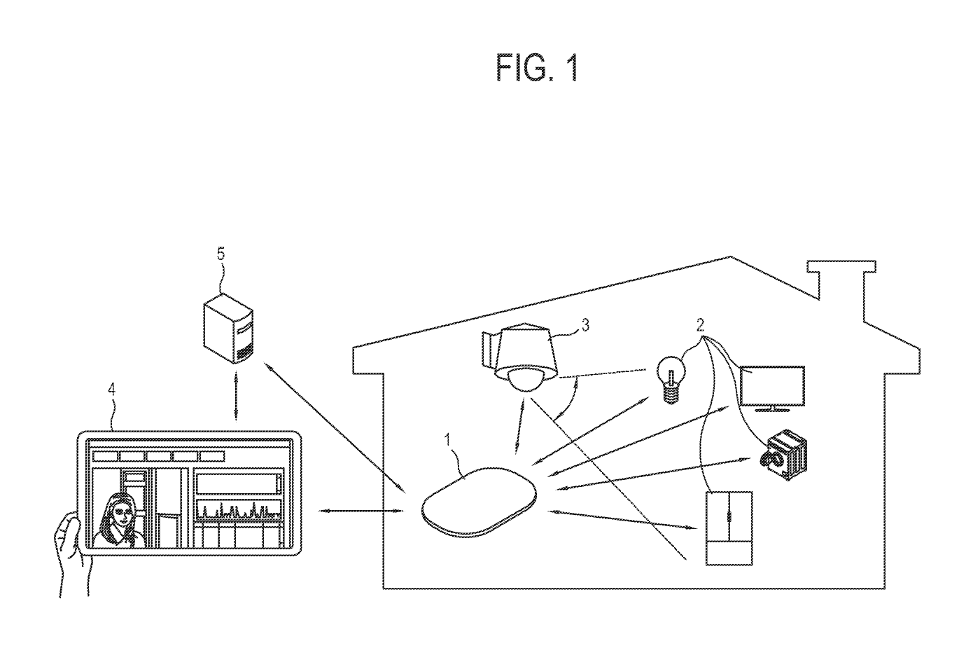

FIG. 1 illustrates a gateway apparatus and various electronic devices according to an embodiment of the present disclosure.

Referring to FIG. 1, the figure illustrates electronic devices 2 such as a TV, a washing machine, a refrigerator, an electric heating appliance, -or the like, being used at home. According to an embodiment of the present disclosure, the electronic devices may include not only the electronic device used at home but also any device having an electronic configuration, such as an office machine, industrial electronic equipment, or the like, irrespective of use.

In an embodiment, the gateway apparatus 1 may be placed in a space adjacent to the electronic devices 2 in order to monitor the electronic devices 2. For example, at home, the gateway apparatus 1 may be placed in a space such as a living room, and in individual rooms provided with the electronic devices 2 such as a TV, a washing machine, a refrigerator, an electric heating appliance, or the like.

In an embodiment, a camera 3 is employed for monitoring the electronic devices 2. The camera 3 takes an image of the electronic device 2 (hereinafter, referred to as a ‘taken image’), and sends it to the gateway apparatus 1. The camera 3, in an embodiment, has a function of moving a focus for taking an image. Using this function, the camera 3 can take an image focused on one from among many electronic devices 2.

The gateway apparatus 1 monitors the electronic devices 2, and, if there is something wrong with the electronic devices 2, controls the camera 3 to take an image of a relevant electronic device 2. The gateway apparatus 1 provides a user's terminal 4 (hereinafter, referred to as a ‘user terminal’) or a management server 5 with an image containing information enabling a user to check whether there is something wrong (hereinafter, referred to as a ‘monitoring image’) based on the taken image of the electronic device 2 having something wrong.

The user terminal 4 is an electronic device such as a mobile phone, a Smart phone, a Smart pad, a Personal Computer (PC), or the like, which can be handled by a user, and which include any device capable of displaying the monitoring image from the gateway apparatus 1. Like an Internet server, the management server 5 may transmit the monitoring image from the gateway apparatus 1 to the user terminal 4.

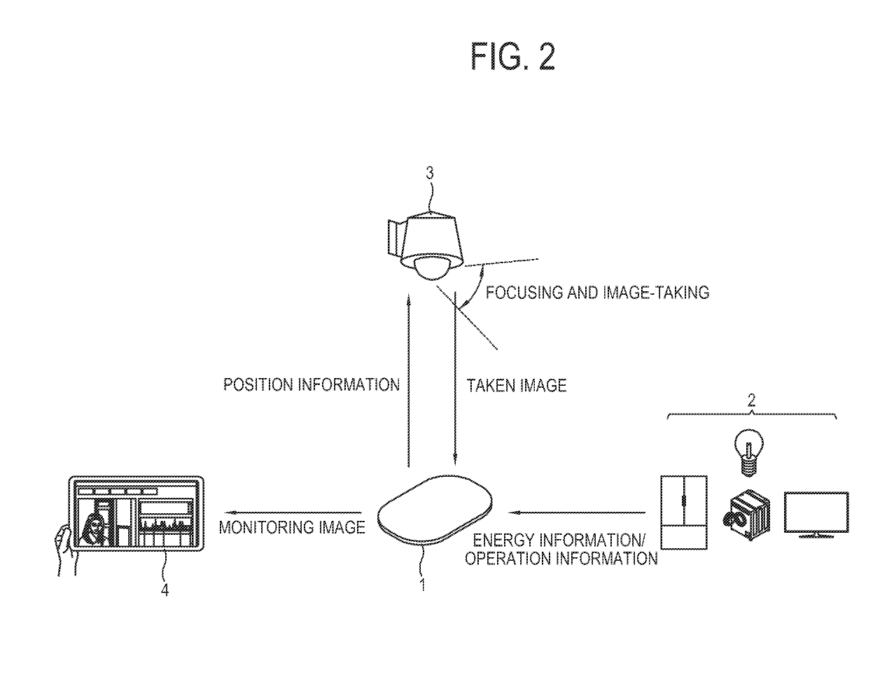

FIG. 2 shows an example of operations of a gateway apparatus according to an embodiment of the present disclosure.

Referring to FIG. 2, the gateway apparatus 1 receives energy information from the electronic devices 2. In an embodiment, the energy information includes information about power energy consumed for operating the electronic devices 2. The gateway apparatus 1 checks whether there is something wrong with the electronic devices 2 based on the energy information from the electronic devices 2. If it is determined that there is something wrong with the operation of the electronic devices 2, the gateway apparatus 1 transmits position information of the electronic devices 2 having something wrong to the camera 3. The camera 3 focuses on the particular electronic device 2 having something wrong, based on the position information, and takes an image of the particular electronic device 2. The camera 3 transmits the taken image to the gateway apparatus 1. The gateway apparatus 1 generates the monitoring image based on the taken image received from the camera 3, and transmits the generated monitoring image to the user terminal 4. The user terminal 4 displays the monitoring image received from the gateway apparatus 1, thus enabling a user to check the particular electronic device 2 with which something is wrong.

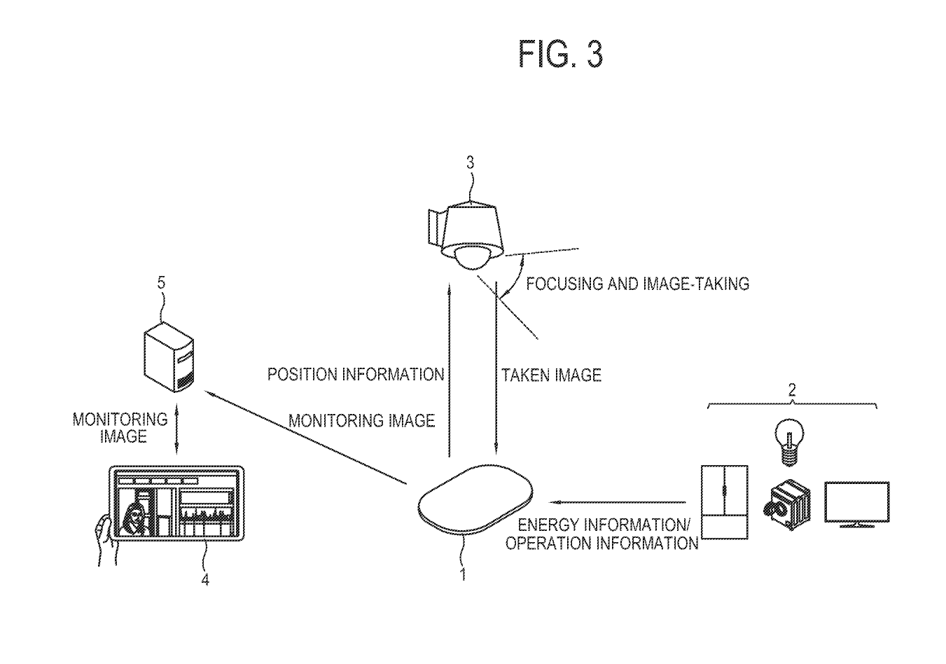

FIG. 3 shows another example of operations of a gateway apparatus according to an embodiment of the present disclosure.

Referring to FIG. 3, the embodiment shown is generally similar to that shown in FIG. 2, but different from that of FIG. 2 in terms of the device to which the monitoring image is transmitted from the gateway apparatus 1. As shown in FIG. 3, in an embodiment, the gateway apparatus 1 transmits a generated monitoring image to the management server 5. The management server 5 transmits the monitoring image from the gateway apparatus 1 to the user terminal 4. The user terminal 4 displays the monitoring image received from the management server 5 so that a user can check the electronic device 2 with which something is wrong.

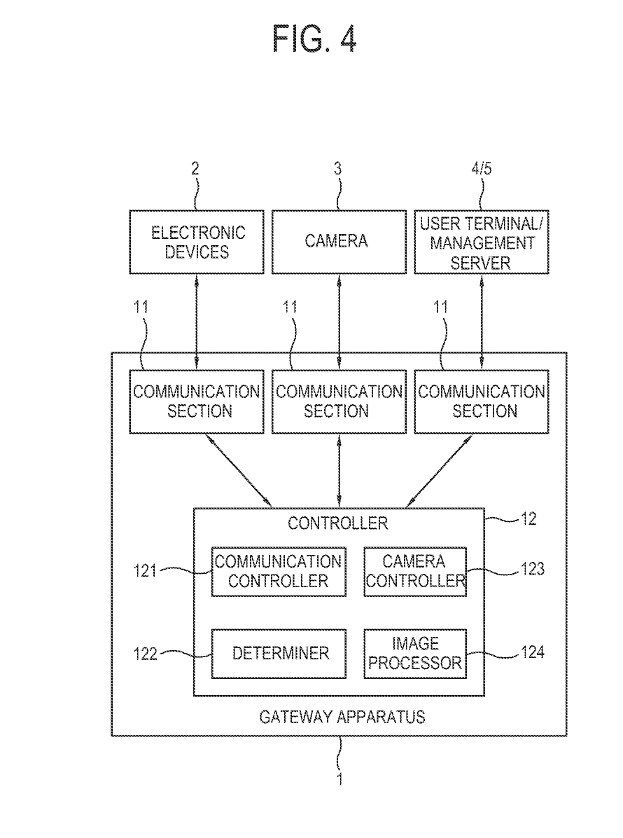

FIG. 4 is a block diagram showing a configuration of a gateway apparatus according to an embodiment of the present disclosure.

Referring to FIG. 4, the gateway apparatus 1 includes a plurality of communication sections 11 and a controller 12. The plurality of communication sections 11 each communicate with the electronic devices 2, the camera 3, the user terminal 4 or the management server 5. The communication sections 11 perform communication in accordance with communication methods adaptive to the corresponding electronic devices 2, respectively. There is no limit to the communication method used in communication with the electronic devices 2, or the like, and all known communication methods may be employed herein. Also, the communication method includes both wired and wireless communication methods. In embodiments, at least two of the plural communication sections 11 may have the same communication method, or may be different in the method of communication. Therefore, at least two communication sections 11 having the same communication method may be achieved.

For example, the communication section 11 may use a Zigbee communication method to communicate with the electronic devices 2. The Zigbee communication method is defined in Institute of Electrical and Electronics Engineers (IEEE) 802.15.4 as standards for local area wireless communication. Meanwhile, the communication section 11 may use a wireless Local Area Network (LAN) such as Wi-Fi to communicate with the camera 3. Wi-Fi is defined in IEEE 802.11n as standards for local area wireless communication. Further, the communication section 11 may use a wireless Local Area Network (LAN) such as Wi-Fi to communicate with the user terminal 4. The communication section 11 may communicate with the management server 5 through the wired or wireless communication method.

In an embodiment, the controller 12 controls monitoring for the electronic devices 2 to be performed based on communication with the electronic devices 2 through the communication section 11. The controller 12 determines whether there is something wrong with the electronic devices 2 based on the energy information received from the plurality of electronic devices 2. If there is something wrong with the electronic devices 2, the controller 12 transmits the position information of the electronic device 2 having something wrong to the camera 3 and receives the taken image of the relevant electronic device 2 from the camera 3. The controller 12 generates the monitoring image based on the received taken image of the electronic device 2, and transmits the monitoring image to the user terminal 4 or the management server 5.

As shown in FIG. 4, the controller 12 may for example include a communication controller 121, a determiner 122, a camera controller 123 and an image processor 124. The communication controller 121 controls the communication section 11 to perform corresponding communication in accordance with situations. The determiner 122 determines whether something is wrong with the electronic devices 2 based on the energy information received from the electronic devices 2. The camera controller 123 transmits the position information of the electronic device 2 having something wrong to the camera 3 and thus receives the taken image of the corresponding electronic device 2 from the camera 3. The image processor 124 generates the monitoring image to be transmitted to the user terminal 4 or the management server 5 based on the taken image of the electronic device 2 received from the camera 3.

The communication section 11 and/or the controller 12 may be achieved by a combination of hardware and software. The hardware may include a non-volatile memory such as a flash memory, or the like, in which a software program for performing the foregoing function is stored, a volatile memory such as a Random Access Memory (RAM) to which at least a part of the stored program is loaded, and a microprocessor such as a Central Processing Unit (CPU) which executes the loaded program.

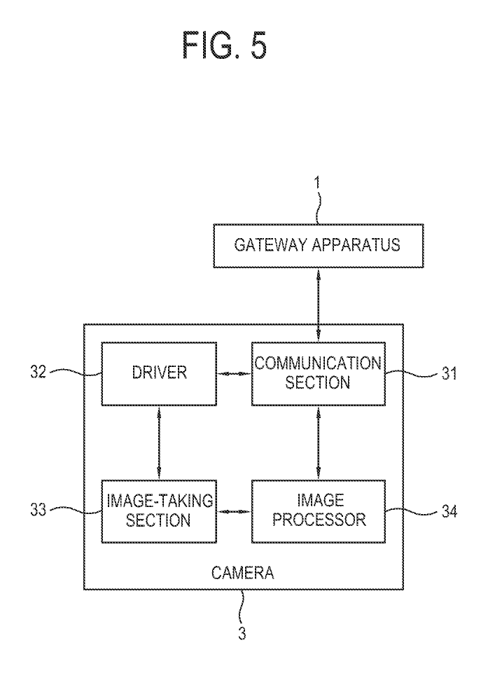

FIG. 5 is a block diagram showing a configuration of a camera according to an embodiment of the present disclosure.

Referring to FIG. 5, the camera 3 may include a communication section 31, a driver 32, an image-taking section 33, an image processor 34, or the like. The communication section 31 communicates with the communication section 11 of the gateway apparatus 1. The communication section 31 receives the position information of the electronic device 2 with which something is wrong from the gateway apparatus 1, and transmits the taken image of the electronic device having something wrong to the gateway apparatus 1. The image-taking section 33 takes an image of the electronic devices 2. The image-taking section 33 has a capability of moving a focus. For example, the image-taking section 33 has at least one function from among a pan, a zoom, and a tilt. The driver 32 controls the image-taking section 33 to move a focus. The driver 32 drives the image-taking section 33 to perform a pan, a zoom, a tilt, or the like, in accordance with the position information received from the gateway apparatus 1, thereby correctly taking an image of the electronic device 2 with which something is wrong. The image processor 34 generates the taken image of the electronic device 2 having something wrong based on information of an image taken by the image-taking section 33. The image processor 34 may use video streaming and transcoding algorithms in processing the taken image.

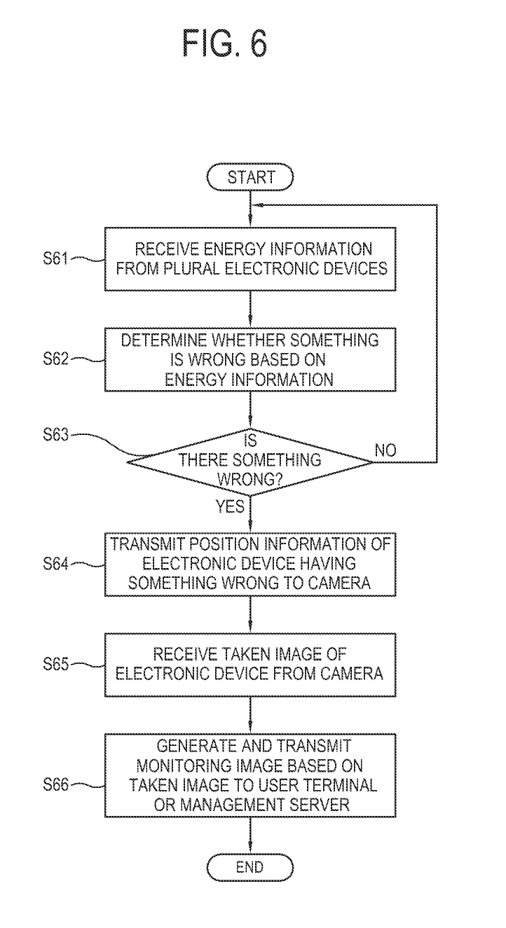

FIG. 6 is a flowchart showing operations of a gateway apparatus according to an embodiment of the present disclosure.

Referring to FIG. 6, at operation S61, the communication section 11 receives the energy information from the electronic devices 2. The transmission of the energy information between the electronic devices 2 and the gateway apparatus 1 may employ Smart Energy Profile (SEP) or Manufacturer Specific Profile (MSP) defined in Zigbee standards (IEEE 802.15.4).

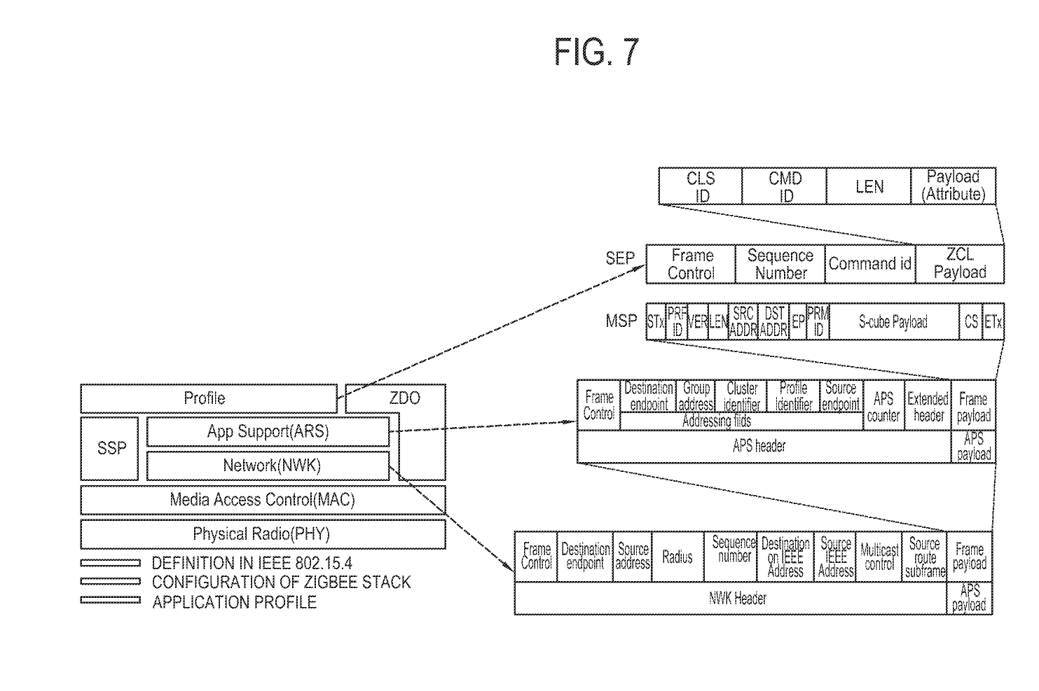

FIG. 7 illustrates an example of a smart energy profile stack according to an embodiment of the present disclosure.

Referring to FIG. 7, the energy information is transmitted from the electronic devices 2 to the gateway apparatus 1 as being embedded in a packet section of a frame of the smart energy profile stack.

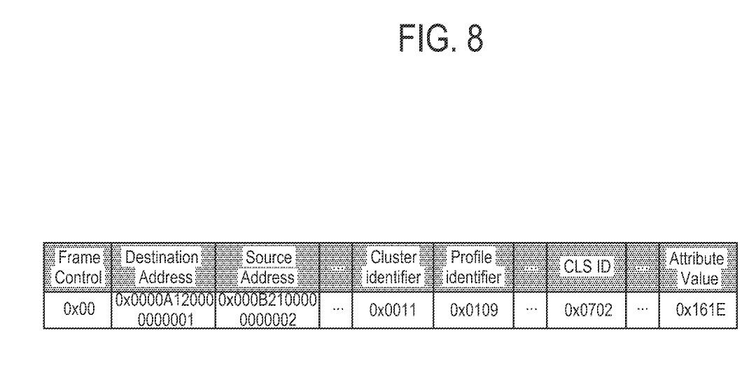

FIG. 8 illustrates a frame structure of a profile containing energy information according to an embodiment of the present disclosure.

Referring to FIG. 8, in the shown frame, a value corresponding to ‘Source Address’ refers to identification information of the electronic device 2 that transmits a packet of a corresponding frame having a ‘Frame Control’ value; a value corresponding to ‘Destination Address’ refers to identification information of the gateway apparatus 1; a value corresponding to ‘Cluster identifier’ refers to cluster information, i.e., the position information of the electronic devices 2; a value corresponding to ‘Profile identifier’ refers to identification information of the relevant profile; a value corresponding to ‘CLS ID’ refers to identification information of a simple metering cluster; and a value corresponding to ‘Attribute Value’ refers to the energy information. In an embodiment, the energy information includes information about the amount of power consumed while the electronic devices 2 operate. For example, as shown in FIG. 8, if ‘Attribute Value’ is 0x161E, it will be appreciated that power of about 5.6 kW is consumed.

Referring back to FIG. 6, if the gateway apparatus 1 receives the energy information from the electronic devices 2, at operation S62 the controller 12 determines whether something is wrong with an electronic device 2 based on the received energy information. The controller 12 may use a probabilistic algorithm in determining whether something is wrong with the electronic devices 2. The probabilistic algorithm may be based on periodic energy consumption of the electronic devices 2, in which the energy information transmitted from the electronic devices 2 to the gateway apparatus 1 may include information about the periodic energy consumption of the electronic devices 2. Specifically, the controller 12 may determine that something is wrong with the operations of an electronic device 2 when the occurrence probability of the current energy consumption of a particular electronic device 2 is lower by a threshold value than that of the previous energy consumption in connection therewith. In an embodiment, the probabilistic algorithm includes a Bayesian estimation method.

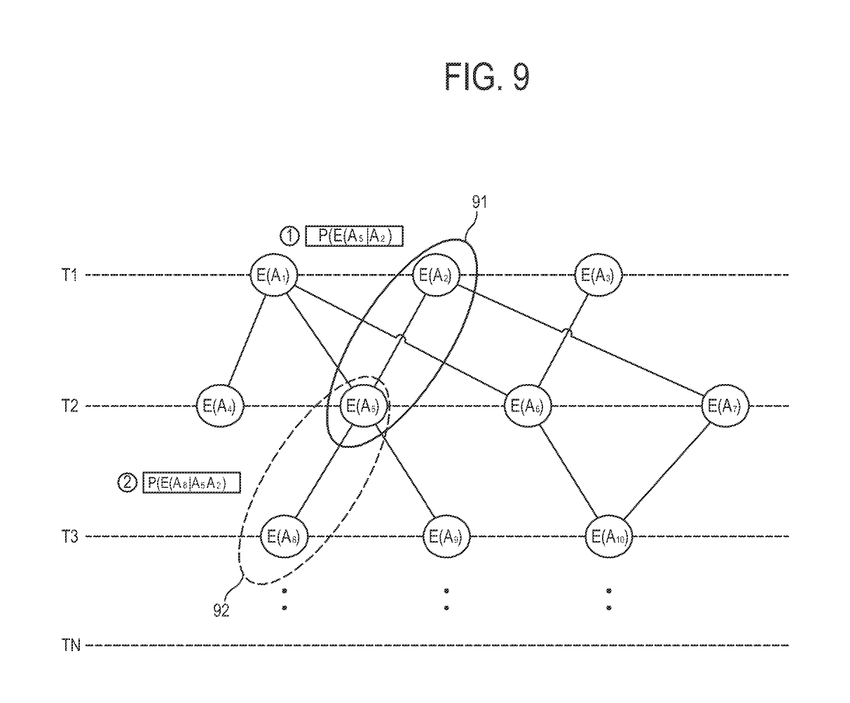

FIG. 9 illustrates a distribution of event occurrence of energy consumption according to an embodiment of the present disclosure.

Referring to FIG. 9, the figure illustrates an embodiment based on the energy information transmitted from the electronic devices 2. In FIG. 9, ‘T1’, ‘T2’, ‘T3’, . . . , and ‘TN’ indicate points of time when the events occur, and ‘E(A1)’, ‘E(A2)’, and so on indicate samples in the respective events. In an embodiment, the samples of the event may correspond to the energy consumption of the electronic devices 2. At the same point of time ‘T1’, ‘E(A1)’, ‘E(A2)’ and so on, indicate the corresponding samples of the respective events, and may denote many events. For example, in one case the events may occur in order of ‘E(A1)-E(A5)-E(A8)’, and in another case the events may occur in order of ‘E(A2)-E(A7)-E(A10)’. As noted below, a series of three or more events may occur, for example, in an order of ‘E(A2)-E(A5)-E(A8)’ as in reference numerals 91 and 92.

The controller 12 obtains a probability of a current event as compared with a previous event based on the distribution of the events shown in FIG. 9.

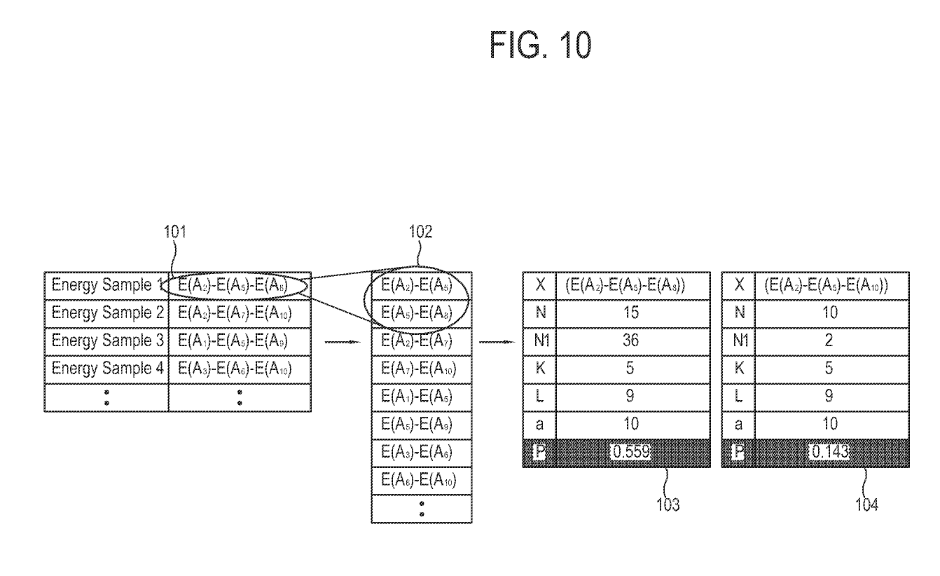

FIG. 10 illustrates probability of each event obtained based on the distribution of an event according to an embodiment of the present disclosure. If a series of three or more events occurs, for example, if the events occurs in order of ‘E(A2)-E(A5)-E(A8)’ (refer to reference numerals of 91 and 92 in FIG. 9, and a reference numeral of 101 in FIG. 10), the probability of the corresponding event may be obtained from two parts ‘E(A2)-E(A5)’ and ‘E(A5)-E(A8)’ (refer to a reference numeral of 102 in FIG. 10).

The probability may be calculated by the following expression.

$$\begin{matrix}C ( D , L ) = {\sum }_{k = {k}^{0}}^{L} \frac{{k}^{0} α + N}{K α + N} P ( k \vert D ) & Equation 1 \\ P ( {X}^{N + 1} = i \vert D ) = \{ \frac{α + {N}_{i}}{{K}^{0} + N} C ( D , L ) & Equation 2 \\ P ( X = i ) = \frac{C ( {N}_{i} + α )}{K α + N} ( C = \frac{N}{N + L - K} ) & Equation 3\end{matrix}$$

In the above expressions, variables are defined as follows.

TABLE 1

| Variables | Definition |
|---|---|
| X | Samples to be observed (E(A1_{T1})E(A1_{T2})E(A1_{T3})) |
| Nᵢ | Total observed samples (packet frequency of receiving energy |
| | information of E(A1_{T1})E(A1_{T2})) |
| | Count(E(A1_{T1})E(A1_{T2})) |
| N | Frequency of certain event occurrence (packet frequency of |
| | (E(A1_{T1})E(A1_{T2})→ E(A1_{T3})) |
| K | Number of another observed events (frequency of |
| | E(A1_{T1})E(A1_{T2}) at previous training) |
| L | Total observed samples (samples that may occur) |
| D | Total observed nodes (number of total observed energy |
| | information nodes) |
| α | User defined value |
| C(D, L) | Scaling factor (all observable samples) |

The controller 12 determines whether the relevant event corresponds to something wrong with the operation of the electronic devices 2 based on the obtained probability. That is, the controller 12 determines whether occurrence probability of the current event is lower than a threshold value as compared with the previous event with respect to an event sample. For example, if the probability of the event occurring in order of ‘E(A2)-E(A5)-E(A8)’ is 0.559 (i.e., greater than a threshold value), the controller 12 determines that the corresponding event normally occurs (refer to a reference numeral of 103 in FIG. 10). Therefore, the controller 12 determines that there is nothing wrong with the corresponding electronic device 2. On the other hand, if the probability of the event occurring in order of ‘E(A2)-E(A5)-E(A10)’ is 0.143 (i.e., lower than a threshold value), the controller 12 determines that the corresponding event abnormally occurs (refer to a reference numeral of 104 in FIG. 10). Therefore, the controller 12 determines that there is something wrong with the corresponding electronic device 2.

Referring back to FIG. 6, at operation S63 if it is determined that there is nothing wrong with the operations of the corresponding electronic device 2, the controller 12 returns to the operation S61. On the other hand, at operation S63 if it is determined that there is something wrong with the operations of the corresponding electronic device 2, at operation S64, the controller 12 controls the communication section 11 to transmit the position information of the electronic device 2 having something wrong to the camera 3. As described with reference to FIGS. 7 and 8, the position information of the electronic device 2 having something wrong may be obtained from the information (e.g., cluster information) embedded in the packet of the smart energy profile received from the corresponding electronic device 2. The position information may include information about a position where the corresponding electronic device 2 having something wrong is placed in a space in which the plurality of electronic devices 2 is placed. Also, the position information may include information about a relative position between the camera 3 and the electronic devices 2 with which something is wrong. Then, as described above the camera 3 moves the focus based on the position information and thus takes an image of the electronic device with which something is wrong.

Next, at operation S65 the controller 12 receives the taken image of the electronic device 2 having something wrong from the camera 3. Then, at operation S66 the controller 12 generates the monitoring image to be provided to a user, based on the taken image, and transmits the generated monitoring image to the user terminal 4 or to the management server 5.

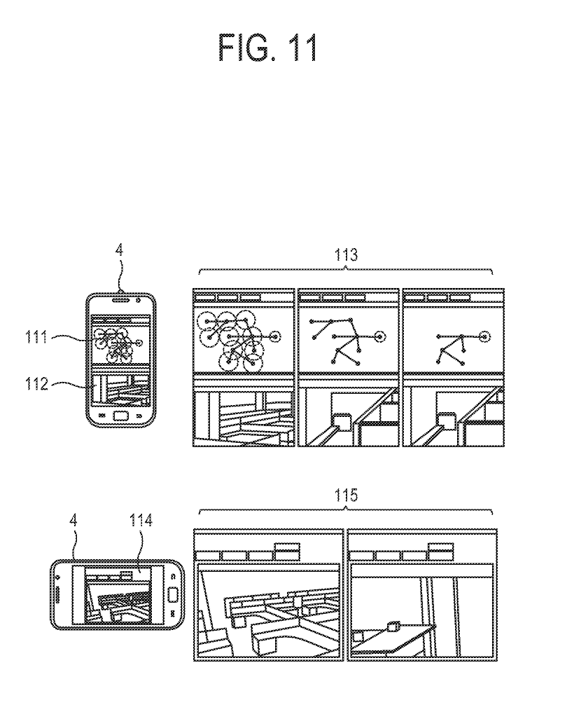

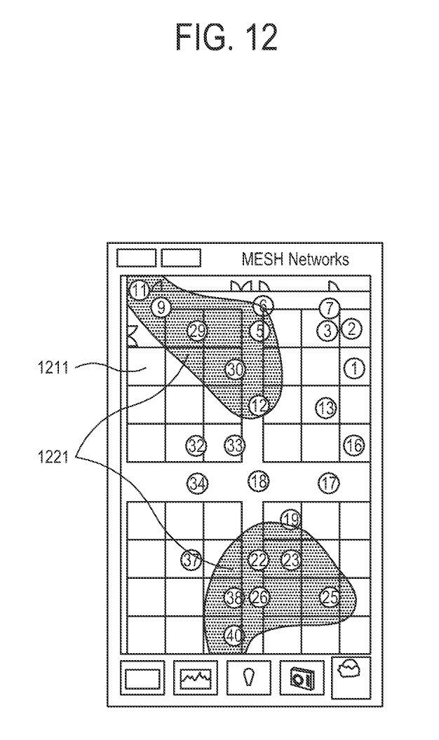

FIGS. 11 and 12 show examples of monitoring images according to an embodiment of the present disclosure.

Referring to FIG. 11, the figure illustrates the monitoring images 111 to 115 displayed on the user terminal 4. The monitoring images may be displayed on the user terminal 4 in a horizontal direction 114 or in a vertical direction 111 and 112. The monitoring image may include a photograph 112 showing the electronic device having something wrong and/or a layout 111 showing the position of the electronic device 2 having something wrong from among the plurality of electronic devices 2. The reference numerals of 113 and 115 show another example of the monitoring image according to an embodiment.

Referring to FIG. 12, the figure shows another example of the monitoring images according to an embodiment of the present disclosure. In an embodiment, the monitoring image may include information of allowing a user to easily recognize a situation in which something is wrong with the operations of the electronic device 2. That is, the monitoring image may include information allowing a user to distinguish an electronic device 2 having something wrong. For example, as shown in FIG. 12, numerals shown in the monitoring image 1211 refer to positions where the plural electronic devices 2 are respectively arranged. From among the numerals, a numeral corresponding to a relatively large consumption of current power energy may be displayed as distinguished from the other numerals. For example, regions indicated by reference numeral of 1221 are remarkable as compared with the other regions in the monitoring image 1211. Thus, a user can intuitively and easily determine that something is wrong with the electronic devices 2 placed in the corresponding region 1221.

Alternatively, the gateway apparatus 1 may determine whether there is something wrong with the electronic devices 2 based on operation conditions previously set with regard to the respective electronic devices 2. For example, the operation conditions may include a condition whereby all the lights in the home have been designated not to be turned on while a homeowner is out after turning off the lights. If the light is turned on even while the homeowner is out, the corresponding light does not satisfy the operation conditions, and it is thus determined that something is wrong with the light. Alternatively, the operation conditions may include a condition whereby the electronic device 2, such as a washing machine, is set up to operate at a certain time, or a condition whereby a refrigerator is set up to operate at a certain temperature. In such a case, if the corresponding electronic device 2 operates outside of the certain time or temperature, it may be determined that something is wrong with the corresponding electronic device 2.

The gateway apparatus 1 may previously store information about the operation conditions with regard to the respective electronic devices 2 in a memory, and may determine whether something is wrong with the operations of the respective electronic devices 2 with reference to the stored information about the operation conditions.

The gateway apparatus 1 may receive operation information of the electronic devices 2 in order to determine whether the operations of the electronic devices 2 do not satisfy the operation conditions. Referring back to FIGS. 2 and 3, the electronic devices 2 may receive the operation information from at least one from among the plural electronic devices 2. The operation information may be transmitted to the gateway apparatus 1 by the electronic device 2 itself that performs the operation. For example, a washing machine, a refrigerator, or the like electronic devices 2, may transmit status information about a current operation such as a wash-driving time, a refrigerating temperature, or the like, to the gateway apparatus 1. Alternatively, one electronic device 2 may transmit the operation information of another electronic device 2 to the gateway apparatus 1. For example, the electronic devices 2 provided with an illuminometer, a temperature sensor, or the like, may sense illumination, temperature, or the like, and may transmit the operation information about the sensed illumination, temperature, or the like, to the gateway apparatus 1.

In terms of transmitting the operation information, Smart Energy Profile (SEP) or Manufacturer Specific Profile (MSP) defined in Zigbee standards (IEEE 802.15.4) described referring to FIGS. 7 and 8 may be used. The gateway apparatus 1 may receive a frame of the smart energy profile stack from the plurality of electronic devices 2, and determine whether something is wrong with the operation of the electronic device 2, based on the operation information of the corresponding electronic device 2 included in a packet section of the received frame.

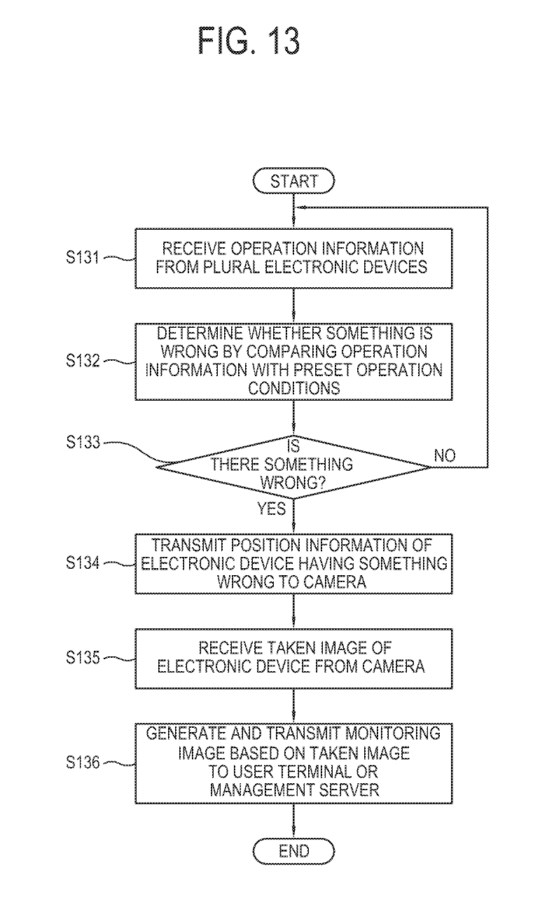

FIG. 13 is a flowchart showing operations of a gateway apparatus according to an embodiment of the present disclosure.

Referring to FIG. 13, at operation S131, the communication section 11 receives the operation information from the plural electronic devices 2. Next, at operation S132, the controller 12 compares the received operation information with the previously stored operation condition, and determines whether there is something wrong with the operation of the corresponding electronic device 2. Then, at operation S133, if it is determined that there is nothing wrong with the operations of the corresponding electronic devices 2, the controller 12 returns to the operation S131. If it is determined at the operation S133 that there is something wrong with the operations of the corresponding electronic devices 2, at operation S134 the controller 12 controls the communication section 11 to transmit the position information of the electronic device 2 having something wrong to the camera 3. Next, at operation S135 the controller 12 receives the taken image of the electronic device 2 having something wrong from the camera 3. Then, at operation S136 the controller 12 generates the monitoring image to be provided to a user based on the taken image, and transmits the generated monitoring image to the user terminal 4 or the management server 5.

Alternatively, the gateway apparatus 1 may determine whether there is something wrong with the operations of the electronic devices 2 based on both the operation information of the electronic device 2 and the energy information. For example, the gateway apparatus 1 may compare energy estimated to be consumed based on the operation information and energy actually consumed based on the received energy information, and may determine that something is wrong with the operation of the electronic device 2 if both energies are not matched with each other.

As described above, according to an embodiment, it is possible to more correctly monitor an electronic device having something wrong, while allowing a user to intuitively check whether there is something wrong with the electronic devices.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A gateway apparatus for monitoring whether something is wrong with electronic devices, the gateway apparatus comprising:
at least one communication section which communicates with a plurality of electronic devices, a camera for taking an image of the plurality of electronic devices, and a user terminal or a management server; and
a controller configured to determine whether there is something wrong with at least one of the plurality of electronic devices based on energy information received from the plurality of electronic devices, to receive a taken image of the at least one electronic devices with which something is wrong from the camera by transmitting position information of the at least one electronic device with which something is wrong to the camera, and to transmit a monitoring image based on the received taken image of the at least one electronic device with which something is wrong to the user terminal or to the management server.

2. The gateway apparatus according to claim 1, wherein the controller determines whether there is something wrong with at least one of the plurality of electronic devices based on operation information received from the plurality of electronic devices.

3. The gateway apparatus according to claim 1, wherein the energy information comprises information about periodic energy consumption of the electronic devices.

4. The gateway apparatus according to claim 3, wherein the controller determines whether there is something wrong with at least one of the plurality of electronic devices using a probabilistic algorithm based on information about the periodic energy consumption of the plurality of electronic devices.

5. The gateway apparatus according to claim 4, wherein the controller determines that something is wrong with at least one of the plurality of electronic devices when an occurrence probability of current energy consumption of the at least one of the plurality of electronic devices with which something is wrong is lower, by a threshold value, than that of previous energy consumption of the electronic device.

6. The gateway apparatus according to claim 5, wherein the probabilistic algorithm comprises a Bayesian estimation method.

7. The gateway apparatus according to claim 1, wherein the communication section receives the energy information from the plurality of electronic devices through Zigbee communication.

8. The gateway apparatus according to claim 1, wherein the monitoring image comprises information to distinguish the at least one electronic device with which something is wrong from among the plurality of electronic devices.

9. A method of controlling a gateway apparatus for monitoring whether something is wrong with electronic devices, the method comprising:
receiving energy information from a plurality of electronic devices;
determining whether there is something wrong with at least one of the electronic devices based on energy information received from the plurality of electronic devices;
when there is something wrong with at least one of the plurality of electronic devices, transmitting position information of the at least one electronic device with which something is wrong to a camera for taking images of the plurality of electronic devices;
receiving the taken image of the at least one electronic device with which something is wrong from the camera; and
transmitting a monitoring image based on the taken image of the at least one electronic device with which something is wrong to the user terminal or management server.

10. The method according to claim 9, wherein the determining of whether there is something wrong comprises determining whether something is wrong with at least one of the plurality of electronic devices based on operation information received from the plurality of electronic devices.

11. The method according to claim 9, wherein the energy information comprises information about periodic energy consumption of the electronic devices.

12. The method according to claim 11, wherein the determining of whether there is something wrong comprises determining whether there is something wrong with the at least one of the plurality of electronic device using a probabilistic algorithm based on information about the periodic energy consumption of the plurality of electronic device.

13. The method according to claim 12, wherein the determining of whether there is something wrong comprises determining that something is wrong with at least one of the plurality of electronic devices when an occurrence probability of current energy consumption of at least one of the plurality of electronic devices with which something is wrong is lower, by a threshold value, than that of previous energy consumption of the electronic device.

14. The method according to claim 13, wherein the probabilistic algorithm comprises a Bayesian estimation method.

15. The method according to claim 9, further comprising: receiving the energy information from the plurality of electronic devices through Zigbee communication.

16. The method according to claim 9, wherein the monitoring image comprises information to distinguish the at least one electronic device with which something is wrong from among the plurality of electronic devices.

17. A gateway apparatus for monitoring whether something is wrong with electronic devices, the gateway apparatus comprising:
at least one communication section which communicates with a plurality of electronic devices, a camera for taking an image of the plurality of electronic devices, and a user terminal or a management server; and
a controller configured to receive operation information from the plurality of electronic devices, to determine whether there is something wrong with at least one of the electronic devices by comparing the received operation information with operation conditions, to receive an image of the at least one of the electronic devices with which something is wrong from the camera by transmitting position information of the at least one electronic device with which something is wrong to the camera, and to transmit the received image of the at least one electronic device with which something is wrong to the user terminal or to the management server.

18. A method of controlling a gateway apparatus for monitoring whether something is wrong with electronic devices, the method comprising:
receiving operation information from a plurality of electronic devices;
determining whether there is something wrong with at least one of the plurality of electronic devices by comparing the received operation information with operation conditions;
transmitting position information of the at least one of the electronic devices with which something is wrong to a camera for taking images of the plurality of electronic devices if something is wrong;
receiving the image of the at least one electronic device with which something is wrong from the camera; and
transmitting a monitoring image based on the taken image of the at least one electronic device with which something is wrong to a user terminal or to a management server.

19. A non-transitory computer-readable storage medium storing instructions that, when executed, cause at least one processor to perform the method of claim 9.

20. A non-transitory computer-readable storage medium storing instructions that, when executed, cause at least one processor to perform the method of claim 18.
